(19) United States
(12) Patent Application Publication
(10) Pub. No.: US 2018/0329619 A1
(43) Pub. Date: Nov. 15, 2018

(54) AGRICULTURAL MACHINE

(71) Applicant: CLAAS Tractor SAS, Velizy-Villacoublay Cedex (FR)

(72) Inventors: Jan Carsten Wieckhorst, Paderborn (DE); Ralf Müller, Schonbeck/OT Pretzien (DE); Christian Ehlert, Bielefeld (DE); Claus Mörsch, Langenberg (DE); Robin Schütte, Weine (DE)

(73) Assignee: CLAAS Tractor SAS, Velizy-Villacoublay Cedex (FR)

(21) Appl. No.: 15/975,102

(22) Filed: May 9, 2018

(30) Foreign Application Priority Data
May 10, 2017 (DE) 102017110159.4

(51) Int. Cl. G06F 3/0484; G06F 3/0482; G06F 3/0488; A01B 69/00; B62D 49/06

(52) U.S. Cl. CPC G06F 3/04847; G06F 3/0482; G06F 2203/04803; A01B 69/007; B62D 49/0614; G06F 3/04886

(57) ABSTRACT

An agricultural machine, such as a tractor, includes a control or regulating system for controlling and regulating a working assembly in order to perform an agricultural work order. The control and regulating system includes at least one control unit with a control program. The control program is configurable and/or loadable as a function of any one, any combination or all of: the agricultural work order; the attachable working assembly; or operator input relating to an agricultural work order.

### CROSS REFERENCE TO RELATED APPLICATION

This application claims priority under 35 U.S.C. § 119 to German Patent Application No. DE 102017110159.4, filed May 10, 2017, the entire disclosure of which is hereby incorporated herein by reference.

### TECHNICAL FIELD

The technical field relates to an agricultural machine. More specifically, the technical field relates to an agricultural machine, such as a tractor, that includes a control program that is configurable and/or loadable based on one or more aspects.

### BACKGROUND

EP 0 201 658 B1 discloses an agricultural machine, such as a tractor, that includes an electronic dosing system for attachable working assemblies in the form of attachment distribution systems. The agricultural machine includes a microprocessor which coordinates with the various distributing machines. This co-ordination with the various distributing machines is effected by means of a coding system, so that the individual characteristics of the respective distributing machine can be recognized, whereby by means of this coding system, the basic element automatically recognizes which distributing machine is coupled to the tractor and/or which partial widths, wherein various computer and control programs are stored in the microprocessor in the basic element, and wherein the signals transmitted automatically cause the correct program to be called up.

### DESCRIPTION OF THE FIGURES

The present application is further described in the detailed description which follows, in reference to the noted plurality of drawings by way of non-limiting examples of exemplary implementation, in which like reference numerals represent similar parts throughout the several views of the drawings, and wherein:

FIG. 1A illustrates a schematic view of a first exemplary implementation of an agricultural machine;

FIG. 1B illustrates a schematic view of a second exemplary implementation of an agricultural machine; and

FIG. 2 illustrates a schematic representation of the flow diagram for a control and regulating system of an agricultural machine according to FIGS. 1A-B.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

A control program, such as that illustrated in EP 0 201 658 B1, is a standard control program that is used for the respective control of the internal or external working assembly, i.e., a control program which has to be sufficient for all operating states of the respective working assembly of the agricultural machine. Using such a standard control program requires that the control program covers all operating states of the internal and external working assemblies, thereby accounting for different targets (which may conflict) and which may not be optimal.

Thus, in one implementation, an agricultural machine is disclosed which improves the control aspect of the agricultural machine, including configuration and/or loading of the control program based on one or more aspects. Example aspects include, but are not limited to, any one, any combination, or all of: the working assembly (e.g., internal working assembly and/or external working assembly); the agricultural work order (or agricultural work task, which may be used interchangeably); operator input related to the agricultural work order; one or more operating parameters of the agricultural machine; or one or more environmental parameters. In this way, the control of the agricultural machine may be improved (such as optimized). Aspects related to control of the agricultural machine which may be improved include any one, any combination, or all of: generation of the control program; loading of the control program; or execution of the control program.

In one implementation, the agricultural machine is a tractor. Alternatively, the disclosed solution may be used on any other type of agricultural machine, such as, for example, a combine harvester, a forage harvester, or a field shredder. In this regard, any discussion below regarding a tractor may likewise be applied to any other type of agricultural machine, such as applied to a combine harvester, a forage harvester, or a field shredder.

In one implementation, the agricultural machine comprises a control and regulating system for the control and regulation of at least one aspect of the agricultural machine (such as working assembly for carrying out or supporting an agricultural work order. The term “working assembly” may include one or both of internal working assembly and external working assembly. Examples of internal working assemblies or components of the agricultural machine include the propulsion drive motor or the propulsion transmission. Examples of external working assemblies, such as attachable working assemblies, include a plough or a baler. Other types of internal working assemblies and external working assemblies are contemplated.

In one implementation, the one or more control units of the control and regulating system each have a control program which is configurable and/or loadable as a function of one or more aspects, such as: the agricultural work order; the attachable working assembly (or attachment device); and/or an operator input relating to an agricultural work order. Thus, in a first specific implementation, the loading of the control program (e.g., in what electronic device the control program is loaded) is dependent on the one or more aspects. For example, the control program may be specifically loaded or stored into the respective control unit for a specific agricultural work order and/or a corresponding attachment device. In particular, the agricultural machine may include a plurality of control units. The selection of a specific control unit, selected from the plurality of control units, may depend on the agricultural work order; the attachable working assembly; and/or an operator input relating to an agricultural work order. Alternatively, or in addition, in a second specific implementation, the configuration of the control program (e.g., the content of the control program and/or the functions (e.g., rules) that is included in the control program) is dependent on the one or more aspects. For example, the control program may be configured specifically with respect to a work order and/or specifically with respect to a working assembly.

In one implementation, the control and regulating system comprises a plurality of control units which, or the control programs of which, are each assigned to a specific work order and/or working assembly. As merely one example, a first type of work order may be correlated to a first control unit and a second type of work order may be correlated to a second control unit. As merely another example, a first type of assembly unit may be correlated to the first control unit and a second type of assembly unit may be correlated to a second control unit. Responsive to the selection of the specific control unit, the control program (such as the control program configured or tailored as discussed herein) may be loaded into the selected specific control unit. For example, responsive to determining that the agricultural work order is the first type of agricultural work order, the first control unit is selected for loading the control program. As another example, responsive to determining that the assembly unit is the second type of assembly unit, the second control unit is selected for loading the control program.

The working assembly, such as the attachable working assembly, may be identified by the agricultural machine in one of several ways. In one way, the agricultural machine (such as the control and regulating system and/or the control program) may automatically determine one or more aspects of the working assembly (such as the type of attachable working assembly) upon connection of the working assembly to the agricultural machine. Responsive to this determination, the control and regulating system may then automatically determine one or more of the aspects, such as the agricultural work order, and suitably configure and/or load the respective control program based on the determined one or more aspects (e.g., based on the determined agricultural work order configure and/or load the respective control program). Additionally, or alternatively, another way to determine the one or more aspects is based on operator input. For example, the operator may submit operator input. The operator input may comprise any one, any combination, or all of: an indication of the agricultural work order and/or the working assembly (e.g., the attachable working assembly or the attachment device. For example, the operator may enter, such as via an input device or in the control and regulating system on the agricultural machine, the agricultural work order to be performed and/or the attachment device. The entry by the operator may be based on a suggestion of the agricultural machine (e.g., the input device displays a plurality of possibilities, such as a plurality of potential agricultural work orders and/or a plurality of attachment devices, and the operator selects and/or confirms from one or more displayed possibilities). Alternatively, or in addition, the operator may input the agricultural work order to be performed and/or the attachment device without prompting or suggestion by the input device.

Thus, a specific control program may be adapted based on the one or more aspects discussed herein, such as adapted for the agricultural work order, the attachable work assembly; and/or the operator input relating to the agricultural work order. In particular, the specific control program may be adapted based on any one, any combination, or all of: the agricultural work order (e.g., based on the type of agricultural work order and/or based on operator input related to the agricultural work order); the working assembly (e.g., based on the type of internal working assembly and/or the type of external working assembly); the operating parameters (e.g., prediction of some aspect, such as speed, power, working depth, or weight, regarding expected load states for a respective work order); or environmental parameters (e.g., type of terrain, type of soil, type/moisture of harvest; headland). In this way, a specifically adapted control program and/or control unit may thus be tailored to the specific application at issue, taking into account different target specifications, thereby improving performance. Further, due to the specific adaptation, the control program may be smaller (e.g., include fewer and/or less complicated rules) than a standard control program (which may include rules for configurations other than the specific current configuration). In this way, the control program may be tailored to control one or more aspects of the agricultural machine, such as any one, any combination, or all of: the driver assistance system; the transmission; or the propulsion drive. More specifically, the control program may be configured or tailored so that any one, any combination or all of the following activities may be controlled: control output torque (e.g., responsive to identifying that the agricultural work order is a first type (such as “front loading bulk material” or “silage pushing”), the control program is configured or tailored to allows a change in output torque by the operator (at least up to a certain degree or completely); responsive to identifying that the agricultural work order is a second type (such as “soil cultivation”), the control program is configured or tailored to prevent a change in output torque by the operator); reaction to external interferences; adaptation of engine rotational speed of the agricultural machine; adaptation of power fluctuation of the attachable working assembly; oil circulation of the agricultural machine; starting behavior of power takeoff shaft; or clutch engagement of power takeoff shaft. These activities are merely for illustration purposes. Other activities of the agricultural machine are contemplated. Further, this adapting of the control program eases the burden of the operator in configuring the agricultural machine, resulting in greater efficiency when executing the respective agricultural work order.

In one implementation, the agricultural machine comprises an input/output unit configured to receive input relating to an agricultural work order (e.g., an indication of the agricultural work order) performed by the operator. In a first specific implementation, the input/output unit may be part of the driver assistance system. In a second specific implementation, the input/output unit may be separate from the driver assistance system. The input/output unit may also be designed to display virtual operating elements, thereby enabling potential inputs (e.g., input information), such as drag and drop operating elements and/or virtual keys. Alternatively, or in addition, the input/output unit may be configured to display information which corresponds to settings to be performed and/or inputs performed. The operator may thus perform any one, any combination, or all of the following types of inputs: textual inputs; symbol-based inputs; or select from a group of default selection possibilities which are displayed by the input/output unit.

In one implementation, the control and regulating system is designed that the configuring and/or loading of the control program of the respective control unit occurs in an automated manner responsive to entry or selection of (i) an agricultural work order, (ii) a working order strategy relating to an agricultural work order, (iii) a condition, and/or (iv) an attachable working assembly relating to an agricultural work order and/or responsive to attaching an attachable working assembly.

Thus, in one implementation, the control and regulating system is configured to automatically recognize that an attachable working assembly has establishing a mechanical connection and/or wire-bound or wireless data connection between agricultural machine and the respective attachable working assembly. Responsive to the control and regulating system recognizing or determining that the attachable working assembly has establishing a connection (e.g., mechanical or data), the control and regulating system may determine one or more aspects (such as one, some or all of the agricultural work order, the condition, and one or more aspects of the attachable working assembly).

Further, in one implementation, the configured and/or loaded control program may thus configure the agricultural machine and/or of the attachable working assembly, and/or adapt the control and regulating behavior of the agricultural machine and/or of the attachable working assembly to any one, any combination or all of: the agricultural work order; a working order strategy relating to an agricultural work order; a condition; and/or an attachable working assembly relating to an agricultural work order.

In one implementation, the configuration and/or loading of the control program may take into account operating parameters of the agricultural machine and/or environmental parameters, such as the terrain. For example, the operating parameters may be used for configuring the control program to predict expected load states for a respective work order. The prediction of the expected load states for a respective work order may thus be taken into account by the particular control program in controlling the operation of the agricultural machine. The agricultural machine may obtain the operating parameters in one of several ways. In one way, the operating parameters can be stored or are stored in an internal database (e.g., stored in a database of the agricultural machine). Thus, the agricultural machine may access the operating parameters stored in the internal database. In another way, the operating parameters may be stored in an external database, which is located outside the agricultural machine. Thus, the agricultural machine may access the operating parameters stored in the external database. Prior to the configuration and/or the loading of the control program, the individual parameters can have been stored and/or updated, for example during the course of a previous agricultural work order of the same type. In this way, the operating parameters from the previous agricultural work order may be correlated based on type or aspects. The agricultural machine, determining the type or aspects for the current agricultural work order, may search for similar types or aspects in order to locate operating parameters from similar previous agricultural work order(s). Examples of operating parameter(s) of the agricultural machine, which can be used as a basis when selecting and/or adapting the control program include any one, any combination or all of: aspect relating to speed (e.g., average travelling speed, such as working speed of the agricultural machine); aspect relating to power (e.g., the average power requirement of the attachable working assembly, the average power fluctuation of the attachable working assembly, etc.); aspect relating to the attachable working assembly (e.g., the working depth of the attachable working assembly such as during ploughing); aspect relating to the agricultural machine (e.g., the weight of the agricultural machine alone, the weight of the agricultural machine along with the attached working assembly, and/or the weight of the attachable working assembly). Examples for the environmental parameter(s), which can be used as a basis when selecting and/or adapting the control program include any one, any combination or all of: aspect related to the field (e.g., the presence or absence of a field); aspect related to the soil (e.g., the type of soil, the soil condition, and/or the soil moisture); aspect related to the terrain (e.g., the hilly nature of the terrain); aspect related to the harvest (e.g., the type of harvest material and/or the moisture of the harvest material); and aspect related to the headland (e.g., the presence or absence of a headland).

In one implementation, the control and regulating system may operate in one of multiple modes, such as a preparation mode and a working mode. Further, the control and regulating system may switch between the preparation mode and the working mode. The preparation mode allows configuring and/or loading the control program as previously discussed. In the working mode, the control program configured and/or loaded as such is executed. Additionally or alternatively, the working mode allows capturing and/or storing of the at least one operating parameter and/or environmental parameter performing the agricultural work order. The respective operating parameter may then be used as a base directly in the working mode or for a configuring and/or loading of a control program for an agricultural work order subsequently performed.

In one implementation, various agricultural work orders are contemplated. For example, the agricultural work orders, which may be input or selected by the operator or be automatically selected by the control and regulating system, may include: “front loading bulk material”; “stacking objects”; “silage pushing”; “soil cultivating”; and “transport”. Alternatively, or in addition, various working assemblies are contemplated. For example, the working assemblies, which may perform the agricultural work order, may include: for the agricultural work order “front loading of bulk material”, a front loader bucket; for the agricultural work order “stacking of objects”, a lift truck fork; for the agricultural work order “silage pushing”, a silage or feed pusher; for the agricultural work order “soil cultivation”, a plough, a grubber, etc.; or for the agricultural work order “transport”, a trailer.

The control program may control various aspects of the agricultural machine and/or the attached working assembly. In one implementation, the configured and/or loaded control program controls a stepped or stepless transmission of the agricultural machine and/or configured the driver assistance system of the agricultural machine. In another implementation, through any one, any combination, or all of: (i) the configured and/or loaded control program; (ii) the controlling of the transmission; or (iii) through the configured driver assistance system, any one, any combination, or all of the following may be adapted to an agricultural work order; a working order strategy relating to an agricultural work order; a condition and/or an attachable working assembly relating to an agricultural work order: the starting, turning, deceleration, acceleration and/or reverse driving behavior; the torque build-up; the selection of transmission ratio; the selection of the engine rotational speed; the starting gear; or the shifting strategy of the agricultural machine.

In another implementation, the control and regulating system and/or the control program is designed in such a manner so that any one, any combination, or all of the following be kept constant independently of a change of the weight of the agricultural machine and/or of the attachable working assembly: the starting, turning, deceleration, acceleration and/or reverse driving behavior; the torque build-up; the selection of the transmission ratio; the selection of the engine rotational speed; the starting gear; or the shifting strategy.

In yet another implementation, the control and regulating system and/or the control program is designed in such a manner that with entered or selected agricultural work order “front loading bulk material” and/or “silage pushing”, the driver assistance system allows a change of the output torque of the agricultural machine by the operator at least up to a certain degree or completely, and/or with entered or selected work order “soil cultivation”, the driver assistance system prevents a change of the output torque of the agricultural machine by the operator, wherein the control and regulating behavior of the agricultural machine occurs as a function of the output torque or independently of the output torque.

In still another implementation, the driver assistance system reacts to external interferences by way of the configured and/or loaded control program, and/or adapts the average engine rotational speed of the agricultural machine, the average power requirement of the attachable working assembly, the average power fluctuation of the attachable working assembly, and/or the oil circulation of the agricultural machine to an entered or selected agricultural work order and/or an entered or selectable attachable working assembly and/or an entered or selected headland sequence or a headland sequence assigned to an agricultural work order.

In yet another implementation, through the configured and/or loaded control program, the starting behavior and/or clutch engagement behavior of the power takeoff shaft can be adapted to an entered or selected attachable working assembly.

In this way, different control and regulating possibilities of the agricultural machine and/or of the respective attached working assembly may be achieved by a work order-specific or working assembly-specific control program. Accordingly, a driver assistance system and/or a transmission, such as the propulsion drive, of the agricultural machine may be controlled by the control program, starting, turning, deceleration, acceleration and/or reversing behavior, the torque build-up, the choice of transmission ratio, the choice of engine rotational speed, the starting gear and/or the shifting strategy may be influenced, changes of the output torque of the agricultural machine on the operator side may be permitted or prevented, external order-specific interferences can be taken into account in advance or during the performance of the agricultural order and/or average travelling speed, the average power requirement of the attachable working assembly, the average power fluctuation of the attachable working assembly, and/or oil circulation can be adapted; and/or the starting behavior and/or clutch engagement of a power takeoff shaft can be adapted.

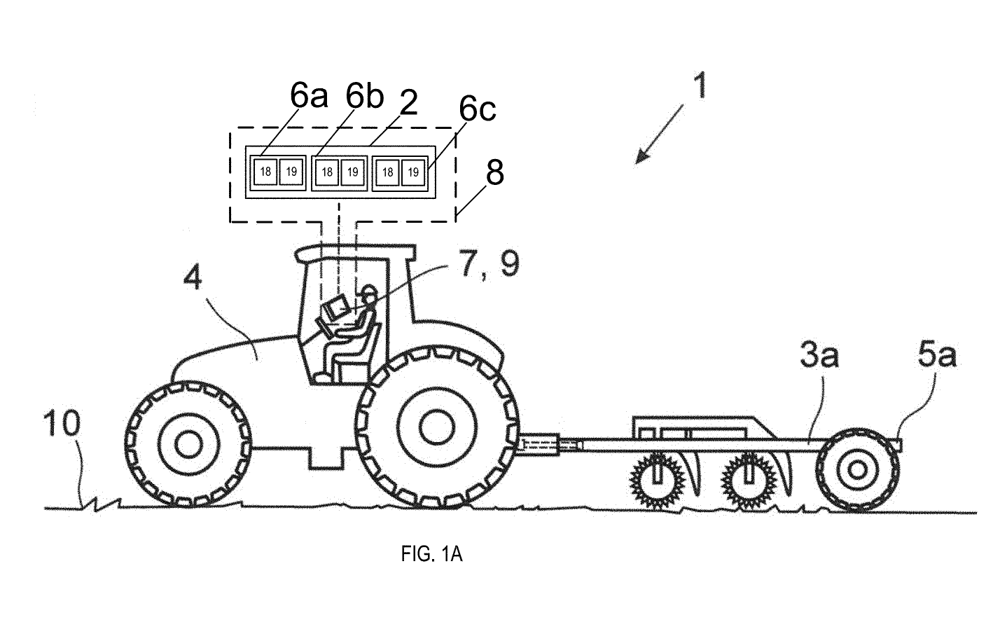

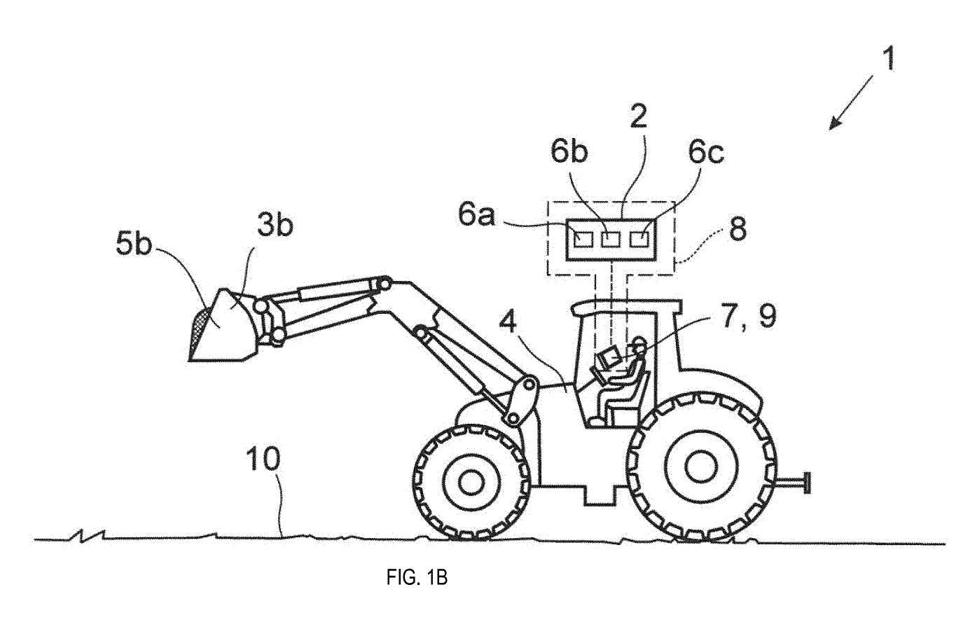

Referring to the figures, FIGS. 1A-B illustrate different exemplary implementations of the agricultural machine 1. The agricultural machine 1 disclosed allows a work order-specific and/or attachment device-specific or working assembly-specific configuration of a control and regulating system 2. The control and regulating system 2 is provided for controlling and regulating at least one internal or external working assembly 3a, 3b for performing or supporting an agricultural work order. In the case of a front loader, the front loader bucket 5b and the propulsion drive motor and/or the propulsion transmission (not shown) as external working assembly 3b and internal working assembly respectively assigned to this application is controlled or regulated, the latter in particular for changing or limiting the engine rotational speed and thereby influencing the drive torque and/or the hydraulics.

FIGS. 1A-B show how an agricultural machine 1, such as a tractor 4, performs a certain agricultural work order using an attached working assembly 3a, 3b, which may also be called attachment device. Accordingly, soil cultivation, namely in this case by means of a grubber 5a as working assembly 3a is performed in FIG. 1A, whereas in FIG. 1B, exemplarily the front loading of bulk material by means of a front loader bucket 5b as working assembly 3b is performed as work order. Further, though FIG. 1B does not illustrate microprocessor 18 and storage medium 19 in the control units 6a, 6b, 6c, it is contemplated that the implementation of FIG. 1B includes such devices.

In one implementation, the control and regulating system 2 of the agricultural machine 1, such as the tractor 4, is configured to improve control (e.g., optimally control) or regulate, both during a first agricultural work order, the assigned external working assembly 3a (e.g., in the form of the grubber 5a) and/or an assigned internal working assembly (e.g. propulsion drive motor and/or propulsion transmission), as well as during a second agricultural work order the assigned external working assembly 3b (e.g., in a different form than the first agricultural order, such as in the form of the front loader bucket 5b) and/or an assigned internal working assembly (e.g. propulsion drive motor and/or propulsion transmission). To this end the control and regulating system 2 comprises at least one control unit 6a, 6b, 6c, here three control units 6a, 6b, 6c, which each comprise(s) a control program. Fewer or more control units are contemplated. In one implementation, an individual control unit 6a, 6b, 6c is configured as a joint control unit for in each case different working assemblies 3a, 3b. Alternatively, a separate control unit 6a, 6b, 6c is provided for each attachable working assembly 3a, 3b, 3c.

Each of individual control units 6a, 6b, 6c may include a microprocessor 18 and a storage medium 19. The microprocessor 18 may comprise a type of controller, such as processor, a microcontroller, an Application Specific Integrated Circuit (ASIC), Programmable Logic Device (PLD), or Field Programmable Gate Array (FPGA), or the like. Storage medium 19 may comprise one or more types of storage medium, such as volatile memory and/or non-volatile memory. Further, microprocessor 18 and storage medium 19 may be separate devices, communicating via an external bus. Alternatively, microprocessor 18 and storage medium 19 may be within the same device, communicating via an internal bus. Logic, such the functionality described here, may be implemented in software stored in storage medium 19 and/or stored within microprocessor 18, as discussed further below.

The control program of the respective control unit 6a, 6b, 6c is configurable and/or loadable into the respective control unit 6a, 6b, 6c as disclosed, such as a function of any one, any combination, or all of: an agricultural work order; an attachable working assembly or attachment device 3a, 3b; or an operating input relating to an agricultural work order.

After the completed input or selection of a concrete agricultural work order and/or attachable working assembly 3a, 3b, configuring and/or loading of the assigned control program takes place, such as in an automated manner (e.g., without the need of further operator inputs). Alternatively, the operator may provide one or more operating inputs, such as a working order strategy input or a selection of a working order strategy (from a plurality of available working strategies), and/or condition relating to an agricultural work order.

Various agricultural work orders are contemplated. For example, agricultural work orders to be performed include front loading of bulk material (pits), the stacking of objects such as bales, boxes or the like, the silage pushing, the cultivation such as for example ploughing or grubbing, and transport, for example by means of a trailer are exemplarily and non-exhaustively mentioned.

In order to assist the operator and increase the efficiency of the individual work orders, a control program may be individually loaded for the respective agricultural work order to be performed (e.g., planned) into the control unit 6a, 6b, 6c and/or the control program may be adapted in one of several ways, including work order-specifically or working assembly-specifically adapted. This is in contrast to a paramount “standard control program” to address the individual operating states of the various attachable working assemblies 3a, 3b. Unlike the “standard control program”, a control program is provided that improves (such as optimizes) the specific purpose.

In order to be able to load and/or configure the respective control program, the agricultural machine 1 may comprise an input/output unit 7, which may be part of a driver assistance system 8. Further, the driver assistance system 8, in operation, may execute the configured control program. The input/output unit 7 is designed for performing operator inputs relating to an agricultural work order and/or for displaying virtual operating elements and/or for the display of information corresponding to settings to be performed and/or inputs performed. In particular, the input/output unit 7 may comprise a touchscreen 9 which allows entering or selecting an agricultural work order and/or an attachable working assembly 3a, 3b corresponding to or associated with an agricultural work order. The input or selection by the operator can be performed by means of the input/output unit 7 and may be in a text-based and/or symbol-based and in particular prompted manner. The operator may thus be able to determine a specific agricultural work order and/or a specific working assembly 3a, 3b in the form of an attachment device in the control and regulating system 2, which may occur by selecting a work order or working assembly 3a, 3b from a group of default work orders or working assemblies 3a, 3b in the control and regulating system 2.

For example, a representation of the agricultural machine 1 and/or at least one attachable or attached working assembly 3a, 3b is visually displayed on the touchscreen 9, which allows a particularly intuitive operation by the operator.

In one implementation, the attached working assembly 3a, 3b may be automatically detected by the control and regulating system 2 by way of the mechanical attaching and/or electrical connecting to the agricultural machine 1. Accordingly, the respective working assembly 3a, 3b may be connected and communicate with the agricultural machine 1, such as via a wire-based data connection (e.g, ISOBUS connection), or via a wireless connection (e.g., radio or WLAN connection), as a result of which the control and regulating system 2 automatically detects the specific attached working assembly 3a, 3b. Responsive to the automatic detection, the control and regulating system 2 may determine a potential agricultural work order, and may display to the operator the determined potential agricultural work order. Following this, the control program may be configured and/or loaded into the respective control unit 6a, 6b, 6c (which may likewise occur in an automated manner) based on preceding confirmation and/or further inputs by the operator is configured and/or loaded.

The control program, which is configured and/or loaded in a specific case, may control one or more aspects of the agricultural machine 1, such as the agricultural machine 1 itself, or the specific attached working assembly 3a, 3b. For example, the control program may automatically perform a configuration of the agricultural machine 1, for example regulating behavior of aspect(s) of the agricultural machine 1, such any one, any combination, or all of: the driver assistance system 8; the hydraulic system; the tire pressure changing system; or the trailer coupling system. Alternatively, or in addition, the control program may regulate behavior of aspect(s) of the working assembly(ies), including any one, any combination, or all of: one or more further integrated working assemblies (not shown here); or the attachable or attached working assembly 3a, 3b. For example, the configuration of the respective attached or attachable working assembly 3a, 3b may occur specifically through configuring the control unit 6a, 6b, 6c, such as the respective control unit 6a, 6b, 6c assigned in each case to the working assembly 3a, 3b, by way of which the control and regulating behavior of the internal working assemblies (not shown), and/or of the external working assembly 3a, 3b is suitably adapted. Accordingly, the control and regulating behavior of the agricultural machine 1 or of the tractor 4 may also be adapted.

The configuring and/or loading of the control program for the respective specific application purpose may be additionally influenced by or based upon one or more operating parameters of the agricultural machine 1 and/or environmental parameters of the respective terrain 10 associated with the agricultural work order. The operating parameter(s) and/or environmental parameter(s) may be stored in an internal or external database or may have been stored during a preceding agricultural work order. In this way, the control and regulating system can access this stored information to use as the basis for configuring and/or loading the control program.

Various operating parameters are contemplated. For example, operating parameters may include any one, any combination, or all of: the average travelling speed or working speed of the agricultural machine 1; the average power requirement of the attachable working assembly 3a, 3b; the average power fluctuation of the attachable working assembly 3a, 3b; the working depth of the respective attachable working assembly 3a, 3b; the weight of the agricultural machine 1; and the weight of the attachable or attached working assembly 3a, 3b. Other operating parameters are contemplated. Likewise, various environmental parameters are contemplated. For example, environmental parameters may include any one, any combination, or all of: the presence or absence of a field; the type of soil; the soil condition; the soil moisture; the hilly natures of the terrain 10; the type of harvest material; the moisture of the harvest material; and the presence or absence of a headland. Other environmental parameters are contemplated.

The control and regulating system 2 in the agricultural machine 1 and/or the control program of the respective control unit 6a, 6b, 6c may be designed in such a manner that based on an operating parameter and/or environmental parameter, a work order-specific and/or working assembly-specific load profile to be expected can be generated. The expected load profile can then be shown to the operator by means of the input/output unit 7 and in particular be taken into account during the configuration of the driver assistance system 8.

Further, the control and regulating system 2 may switch modes, such as switched between a preparation mode and a working mode. In the preparation mode, the control and regulating system 2 configures and/or loads the control program, as described previously. Here, the working mode, in addition to actually performing the respective agricultural work order, may also capture and/or store the operating parameters and/or environmental parameters. These captured/stored parameters may then be accessed during a same (or similar) subsequent agricultural work order for a further adaptation of the respective control program or for configuring and/or loading a control program in the preparation mode for the same (or similar) subsequent agricultural work order.

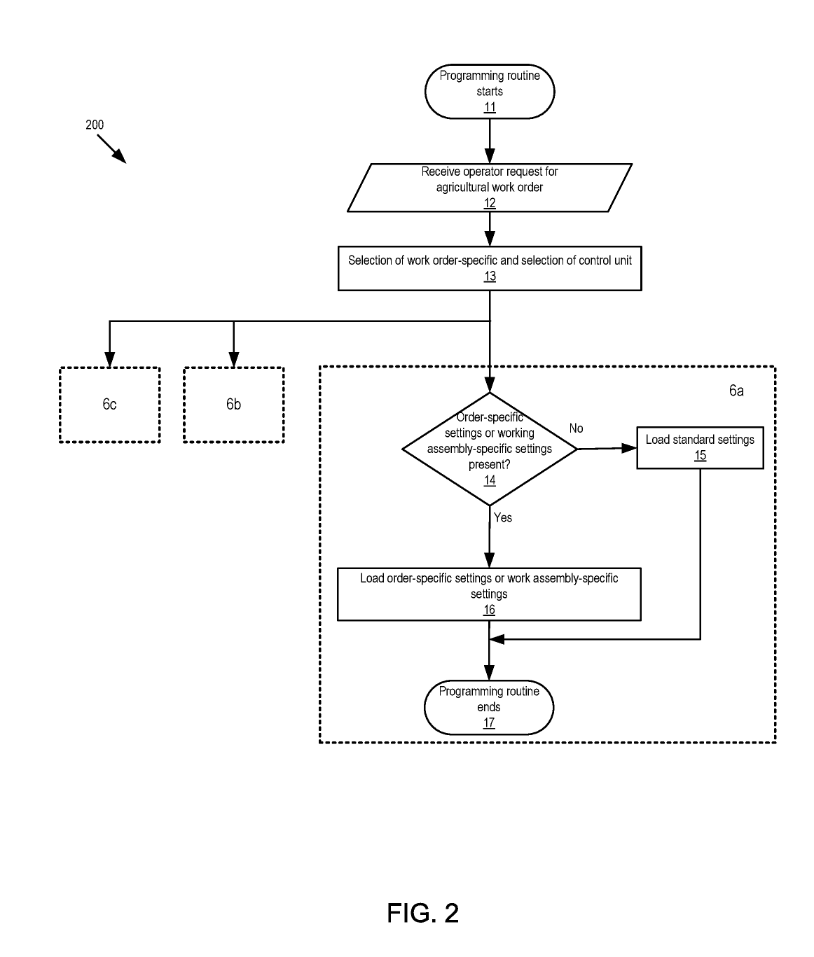

In the following, some specific application examples are described which explain in more detail in the mode of operation of the control and regulating system 2 of the agricultural machine 1. The specific application examples are not intended to be exhaustive, but merely illustrative. FIG. 2, to this end, shows an exemplary representation of individual method steps in the form of a flow diagram 200, which can be provided or performed as proposed. At 11, the programming routine starts. At 12, the operator inputs or selects an agricultural work, which may occur via the described input/output unit 7. Based on the input or selection at 12, at 13, the system automatically selects a work order-specific and thus also working assembly-specific control unit 6a, 6b, 6c. Thereafter, at 14, the system automatically makes a decision as to whether order-specific or working assembly-specific settings are present (e.g., stored or not). In the case that no work order-specific or working assembly-specific settings are present, at 15, the standard settings are loaded. Otherwise, at 16, the specific work order-specific or specific working assembly-specific settings are loaded. At 17, the programming routine ends. As illustrated in FIG. 2, steps 14-17 may likewise be performed for 6a, 6b, and 6c.

The control program configured and/or loaded based on the loaded settings may control (directly or indirectly) various aspects of the agricultural machine. For example, with the control program configured and/or loaded based on the loaded settings, a stepped or stepless transmission of the agricultural machine 1 can for example be controlled and/or the driver assistance system 8 of the agricultural machine configured or adapted. Controlling the transmission, such as the propulsion drive of the agricultural machine 1 or adapting the driver assistance system 8, thus may occur specific to working assembly used or work order performed. Example work orders include, but are not limited to: “front loading bulk material”; “stacking objects”; “silage pushing”; “soil cultivation”; and/or “transport”. The working assembly 3a, 3b may be suitable for one of the aforementioned agricultural work orders, e.g., assigned to one of the aforementioned agricultural work orders. For the agricultural work order “soil cultivation”, a grubber 5a or a plough can for example be provided as the assigned working assembly 3a, wherein the working assembly 3a as mentioned is either automatically detected or entered or selected by an operator (FIG. 1A). For the agricultural work order “front loading bulk material”, the assigned working assembly 3b is for example a front loader bucket 5b, wherein the working assembly 3b is either automatically detected as well or entered or selected by an operator (FIG. 1B).

Through the working assembly-specific or work order-specific configuring of the driver assistance system 8 or transmission, the driving behavior of the agricultural machine 1 may also be adapted accordingly. For example, the starting, turning, decelerating and/or reverse driving behavior can be adapted to an agricultural work order, a working order strategy, a condition relating to a work order and/or an attachable working assembly 3a, 3b. Accordingly, for example, for the agricultural work order “front loading bulk material”, the control program is configured, such as by including a rule, to provide a relatively hard or direct deceleration behavior in order to avoid that the wheels spin when bulk material is picked up, which would create potholes. With the agricultural work order “soil cultivation”, the control program is configured, such as by including a rule, for a soft or slow deceleration of the agricultural machine 1 in order to thereby increase the driving comfort. In the event that a transport is to be provided, the control program may be tailored to control the agricultural machine 1 so that a soft deceleration behavior occurs, thereby preventing dangerous driving situations such as for example a veering of the agricultural machine 1 or of a trailer. In this way, the control program may be tailored with working assembly-specific or work order-specific rules of operation.

The control and regulating system 2 and/or the control program of the respective control unit 6a, 6b, 6c may also be designed in such a manner that a change of the weight of the agricultural machine 1 and/or of the working assembly 3a, 3b, which is conditional on the selection of a certain agricultural work order and/or working assembly 3a, 3b, does not result in a change of the driving behavior. In particular, the control program may control the agricultural machine 1 such that the starting, turning, deceleration and/or reverse driving behavior may be kept unchanged or constant.

Furthermore, in one implementation, the agricultural machine 1 includes the driver assistance system 8 tailored or configured for the specific working assembly and/or for the specific agricultural work order, which includes specific configuration of the torque control dependent on the specific work assembly and/or the specific agricultural work order. For example, the driver assistance system 8 may allow a change of the output torque of the agricultural machine 1 by the operating up to a certain degree or entirely or to prevent the same, depending on the tailoring of the driver assistance system 8 based on the specific work assembly and/or the specific agricultural work order. Accordingly, the driver assistance system 8 may be configured to allow a change of the output torque of the agricultural machine 1 by at least up to a certain degree, such as when work order the “front loading of bulk material” and/or the “silage pushing” are indicated. For example, the driver assistance system 8 can allow “hard” changes, for example, direct changes of the output torque or slightly softens the change of the output torque (“soft” change). In contrast, with the agricultural work order “soil cultivation”, in order to increase the efficiency, the operator may be prevented from changing the output torque of the agricultural machine 1, which is advantageous in particular with heavy soil cultivation. In this regard, responsive to the system determining that the agricultural work order “soil cultivation”, the driver assistance system 8 may be configured to prevent the operator from changing the output torque of the agricultural machine 1. In this way, the driver assistance system 8 may be tailored to the specific work order.

When the driver assistance system 8 is tailored to the specific work order and/or the specific working assembly, the driver assistance system 8 may also react or respond in a tailored manner to external interferences or peripheral conditions. In one example, the working assembly 3a, 3b strikes the ground, the trailer weight is relatively great, for example with a 30 ton trailer etc. Again, one aspect of the driver assistance system, in this example the driving behavior, may be tailored, such as to external interferences or peripheral conditions. For example, with regard to travelling speed control, the driver assistance system 8 may be optimized by way of a closed-loop regulating circuit to account for the specific external interferences or peripheral conditions present.

Other aspects of tailoring the operation of the driver assistance system 8 are contemplated. For example, with respect to the power takeoff shaft connection between the agricultural machine 1 and the respective working assembly 3a, 3b, the control program may be tailored to the specific respective working assembly 3a, 3b in order to adapt the clutch-engagement behavior to the specific respective working assembly 3a, 3b. Accordingly, clutch-engagement behavior may be different depending on one or more aspects of the respective working assembly 3a, 3b, such as the mass size of the respective working assembly 3a, 3b. Specifically, clutch engagement for working assemblies with a relatively large mass inertia (e.g., such as with a baler) may be preferably be different from clutch engagement behavior for working assemblies with a low mass moment of inertia (e.g., such as with a fertilizer distribution unit). In this regard, the controls aspect of the driver assistance system 8 may be tailored responsive to the indication of the type of working assembly 3a, 3b (e.g., large mass inertia versus low mass inertia).

Yet another aspect of the driver assistance system 8 that may be tailored to the specific work order and/or the specific working assembly may comprise control of the hydraulic system of the agricultural machine 1. In particular, the suitably configured driver assistance system 8 may also adapt the hydraulic system, in particular the oil circulation (the oil supply) of an attached working assembly 3a, 3b work order-specifically or working assembly-specifically, in particular by adapting the engine rotational speed.

The aspects of the driver assistance system 8 that may be adapted or tailored to the specific work order and/or the specific working assembly are merely for example purposes. Other adaption or tailoring of the driver assistance system 8 to the specific work order and/or the specific working assembly are contemplated.

### REFERENCE LIST

1 Agricultural machine

2 Control and regulating system

3a, 3b Working assembly

4 Tractor

5a Grubber

5b Front loader bucket

6a, 6b, 6c Control unit

7 Input/output unit

8 Driver assistance system

9 Touchscreen

10 Terrain

11-17 Flow diagram elements

18 Microprocessor

19 Storage medium

Each of the items listed above may be associated with a single electronic device or may be combined within a single electronic device. Further, with regard to each separate electronic device, processing/memory functionality may be included. For example, any one, any combination, or all of the following may be in a single electronic device with associated with processing/memory functionality: control and regulating system; control unit; input/output unit; driver assistance system; and touchscreen.

The methods, devices, processing, circuitry, and logic described above may be implemented in many different ways and in many different combinations of hardware and software. As discussed above, a microprocessor 18 and a storage medium 19 may be used. The microprocessor 18 and the storage medium 19 are merely one example of a computational configuration. Other types of computational configurations are contemplated. For example, all or parts of the implementations may be circuitry that includes a type of controller, including as an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may implement the functionality described herein and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. An agricultural machine comprising:
a control and regulating system configured to control and regulate a working assembly for performing or supporting an agricultural work order and configured for attachment to the agricultural machine, wherein the control and regulating system comprises at least one control unit with a control program,
wherein the control and regulating system is configured to determine at least one of the agricultural work order, the working assembly, or operator input relating to the agricultural work order;
wherein the control and regulating system:
configures the control program based on the at least one of the agricultural work order, the working assembly, or the operator input relating to the agricultural work order; or
loads the control program into the at least one control unit based on the at least one of the agricultural work order, the working assembly, or the operator input relating to the agricultural work order.

2. The agricultural machine of claim 1, wherein the control and regulating system configures the control program and loads the control program based on the at least one of the agricultural work order, the working assembly, or the operator input relating to the agricultural work order.

3. The agricultural machine of claim 2, wherein the control and regulating system configures the control program and loads the control program based on the agricultural work order, the working assembly, and the operator input relating to the agricultural work order.

4. The agricultural machine of claim 2, wherein the control and regulating system comprises a first control unit and a second control unit; and
wherein the control and regulating system is configured to select a control unit, from the first control unit and the second control unit, in which to load the control program based on the agricultural work order or the working assembly.

5. The agricultural machine of claim 2, wherein the control and regulating system comprises a first control unit and a second control unit; and
wherein the control and regulating system is configured to select a control unit, from the first control unit and the second control unit, in which to load the control program based on the agricultural work order and the working assembly.

6. The agricultural machine of claim 1, further comprising an input/output unit configured to:
input an indication of the agricultural work order by an operator; and
display virtual operating elements in order for the operator to input information regarding the agricultural machine.

7. The agricultural machine of claim 1, wherein the control and regulating system is configured to automatically determine a connection of the working assembly to the agricultural machine; and
responsive to determining the connection of the working assembly to the agricultural machine, control and regulating system is configures the control program or loads the control program into the at least one control unit.

8. The agricultural machine of claim 7, wherein the control and regulating system is configured to automatically determine the connection of the working assembly to the agricultural machine by determining a mechanical connection of the working assembly with the agricultural machine or a data connection between the agricultural machine the working assembly.

9. The agricultural machine of claim 1, wherein the control and regulating system configures the control program configured to control the agricultural machine and the working assembly based on a working order strategy relating to the agricultural work order.

10. The agricultural machine of claim 1, further comprising a database, wherein the database is configured to store at least one operating parameter of the agricultural machine and an environmental parameter; and
wherein the control and regulating system is configured to tailor the control program based on the operating parameter and the environmental parameter.

11. The agricultural machine of claim 10, wherein the operating parameter comprises at least one of average travelling speed of the agricultural machine, average power requirement of the working assembly, average power fluctuation of the working assembly, working depth of the working assembly, weight of the agricultural machine or the working assembly; and
wherein the environmental parameter comprises at least one of presence or absence of a field, type of soil, soil condition, soil moisture, hilly nature of a terrain, type of harvest material, harvest material moisture, or presence or absence of a headland.

12. The agricultural machine of claim 10, wherein the control and regulating system is configured to switch between a preparation mode and a working mode;
wherein the control and regulating system is configured to configure and load the control program in the preparation mode; and
wherein the control and regulating system is configured to capture the operating parameter and the environmental parameter in the working mode.

13. The agricultural machine of claim 1, wherein the agricultural work order comprises “front loading bulk material”; “stacking objects”; “silage pushing”; “soil cultivating”; and “transport”.

14. The agricultural machine of claim 1, wherein the agricultural work order comprises “front loading bulk material”; “stacking objects”; “silage pushing”; “soil cultivating”; and “transport”.

15. The agricultural machine of claim 1, further comprising a stepped or stepless transmission and a driver assistance system; and
wherein the control and regulating system configures the control program based on the at least one of the agricultural work order, the working assembly, or the operator input relating to the agricultural work order in order to control the stepped or stepless transmission and the driver assistance system.

16. The agricultural machine of claim 15, wherein the control program tailors control, based on the agricultural work order and a working order strategy relating to the agricultural work order, of choice of engine rotational speed, starting gear, and shifting strategy.

17. The agricultural machine of claim 1, wherein the control program is configured, based on the working assembly, to control at least one of torque build-up, choice of transmission ratio, choice of engine rotational speed, starting gear or shifting strategy is kept constant independently of a change of weight of the working assembly.

18. The agricultural machine of claim 1, wherein a driver assistance system executes the control program;
wherein, responsive to the agricultural work order comprising one of “front loading bulk material” or “silage pushing”, the driver assistance system, executing the control program, is configured to allow a change of output torque of the agricultural machine by an operator; and
wherein, responsive to the agricultural work order comprising one of “soil cultivation”, the driver assistance system, executing the control program, is configured to prevent a change of the output torque of the agricultural machine by the operator.

19. The agricultural machine of claim 1, wherein a driver assistance system executes the control program;
wherein the driver assistance system is configured to react to external interferences by way of the configured or loaded control program; and
wherein the driver assistance system is configured to adapt average engine rotational speed of the agricultural machine, average power requirement of the working assembly, average power fluctuation of the working assembly, and oil circulation of the agricultural machine to an entered or selected headland sequence or a headland sequence assigned to the agricultural work order.

20. The agricultural machine of claim 1, further comprising a power takeoff shaft; and
wherein, responsive to the working assembly, the control program is configured to adapt starting behavior and clutch engagement behavior of the power takeoff shaft.
